(19) United States
(12) Patent Application Publication
(10) Pub. No.: US 2006/0222365 A1
(43) Pub. Date: Oct. 5, 2006

(54) SCM-PON using WDM

(75) Inventors: Dae-Kwang Jung, Suwon-si (KR); Seong-Taek Hwang, Pyeongtaek-si (KR); Yun-Je Oh, Yongin-si (KR); Jin-Woo Park, Seoul (KR); Il-Rae Kim, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/395,099

(22) Filed: Mar. 31, 2006

(30) Foreign Application Priority Data
Apr. 1, 2005 (KR) 2005-27719

(51) Int. Cl. H04J 14/00

(52) U.S. Cl. 398/72

(57) ABSTRACT

A SCM-PON using WDM includes: an OLT for transferring downstream data from an external service provider through downstream optical signals and transferring upstream data transferred through upstream optical signals to an outside; an ODN for distributing the downstream optical signals from the OLT and multiplexing the upstream optical signals to the OLT; and a plurality of ONUs for processing the downstream optical signals transferred from the OLT through the ODN and transferring upstream data of subscribers for the OLT through the upstream optical signals, wherein the optical signals between the OLT and the ONUs are divided into wavelength channels with different wavelengths and sub-carrier channels obtained by time-dividing the wavelength channels, and the upstream data and the downstream data are transferred through the sub-carrier channels.

### CLAIM OF PRIORITY

This application claims priority to an application entitled “SCM-PON Using WDM,” filed in the Korean Intellectual Property Office on Apr. 1, 2005 and assigned Serial No. 2005-27719, the contents of which are hereby incorporated by reference.

### BACKGROUND OF THE INVENTION

1. Field of the Invention

The present invention relates to a Sub-Carrier Multiplexing (SCM)-Passive Optical Network (PON) capable of expanding a bandwidth by using a Wavelength Division Multiplexing (WDM) scheme to enable subscribers to share the same resources as in the case of a Time Division Multiplexing (TDM) scheme.

2. Description of the Related Art

Recently, an optical subscriber network technology has emerged to provide various multimedia services based on a rapid increase in demand for the faster Internet and broadband signal transmission. In order to construct such an optical subscriber network, a Fiber To The x (FTTx) technology, which can provide a transmission speed of up to several Gbps by means of an optical fiber is implemented.

The construction of an optical subscriber network ultimately aims at providing a Fiber To The Home (FTTH) which can cope with the new era of ultra high speed communication environment by supplying an optical cable and an optical transmitter to customer premises. A PON has been highlighted as an ideal method for construction of such an optical subscriber network.

A PON provides an ultra high broadband service at a speed of several tens of Mbps by means of an optical cable. Since a PON uses a point-to-multi-point topology for enabling one Optical Line Terminal (OLT) to connect to a plurality of Optical Network Units (ONUs) through a passive optical power splitter, a plurality of subscribers can share the total bandwidth. Accordingly, the PON is advantageous in that a low optical line installation cost is needed as compared with other schemes, and further has less problem in terms of power supply due to use of an external passive apparatus. For these reasons, region communication carriers have been interested in the PON for a long time.

The core of development direction of such a PON technology lies in the development of a system capable of providing a wider bandwidth at a low cost. A first proposed PON is a TDM-based PON. A TDM-based PON may be classified into an Asynchronous Transfer Mode (ATM)-PON and an Ethernet PON (EPON). That is, an ATM-PON, which is proposed by both approval of an International Telecommunications Union-Telecommunication Standardization Sector (ITU-T) and a Full Service Access Networks (FSAN), and an EPON and has been standardized by an IEEE 802.3ah Task Force, correspond to a TDM-based PON which divides a wavelength channel used for transmission/reception according to time slot for use.

In such an existing TDM-based PON, since a plurality of subscribers share one wavelength, each subscriber operates within one wavelength channel that is divided by the number of subscribers. Also, since power divided by the number of subscribers is supplied to each subscriber through a passive optical power splitter, it is necessary to carefully make a power budget when designing a PON. Moreover, since signals to all subscribers are transferred to each subscriber, an upper layer must take charge of security. Furthermore, since each ONU must operate individually, a complicated Media Access Control (MAC) protocol is necessary.

From such a TDM-based PON, a WDM-PON employing a WDM technology has been proposed, in which a plurality of wavelengths are generated in proportion to the number of subscribers (or ONUs) connecting to a PON, wherein one wavelength is assigned to each subscriber, and communication with each subscriber is accomplished through a corresponding wavelength.

FIG. 1 is a block diagram illustrating the construction of a conventional WDM PON.

As illustrated in FIG. 1, the conventional WDM PON assigns each wavelength to L number of ONUs by means of a router 102 such as an Arrayed Waveguide Grating (AWG).

Hereinafter, the construction of the WDM PON will be described in more detail.

The WDM PON may be largely classified into three components, i.e. an OLT 101, a wavelength routing or an optical branching device 102, and an ONU 103.

The OLT 101 includes a multi-wavelength source in order to provide each subscriber (or each ONU) with unique downstream wavelength channels (λ_{Di}, i=1, 2, 3, . . . , N) 105. The downstream wavelength channels are wavelength-divided by the wavelength routing 102 in an optical transmission line 104, and wavelength-divided wavelengths (λ_{D1}, λ_{D2}, . . . , λ_{DN}) 107-1 to 107-N are transmitted to the designated ONUs 103-1 to 103-N.

In the meantime, upstream wavelength channels (λ_{Uj}, j=1, 2, 3, . . . , N) 106 are obtained by wavelength-multiplexing upstream wavelength signals (λ_{U1}, λ_{U2}, . . . , λ_{UN}) 108-1 to 108-N, which are generated from the ONUs 103-1 to 103-N, by means of the wavelength routing 102. The upstream wavelength channels (λ_{Uj}, j=1, 2, 3, . . . , N) 106 are divided into signals, which have been sent from the ONUs 103-1 to 103-N, by a demux and a receiver array in the OLT 101.

The wavelength routing 102 demultiplexes WDM signals transmitted through an optical fiber or WDM-multiplexes separated wavelengths, and functions as a wavelength multiplexer/demultiplexer by means of a wavelength processing device such as an AWG Each of the ONUs 103-1 to 103-N includes both an optical receiver for receiving the downstream data wavelengths 107-1 to 107-N and an optical transmitter for transmitting upstream data.

As described above, the conventional WDM PON assigns one dedicated wavelength to each subscriber by means of the wavelength routing 102 such as an AWG between the OLT 101 and the ONUs 103-1 to 103-N. Thus, as compared with the TDM-based PON, the WDM PON is advantageous in that it can increase the transmission capacity by the magnification of the number of subscribers, provides less security issues (problem of the TDM-based PON) and an MAC, and can easily meet the power budget.

However, in the conventional WDM PON, the number of subscribers is limited as the number of subscribers is dependent on the number of assignable wavelengths.

Further, in view of the current service level, there is no multimedia service requiring bandwidth to the extent that each wavelength with transmission capacity more than several hundreds of Gbps must be assigned to each ONU. Therefore, assigning one wavelength to one subscriber may cause the waste of wavelength resources.

### SUMMARY OF THE INVENTION

Accordingly, the present invention has been made to solve the above-mentioned problems occurring in the prior art and provides additional benefits by providing a SCM-PON using a WDM, which commonly uses a WDM-PON scheme and a TDM-PON scheme, causes all ONUs to use multiple wavelength signals, and assigns each wavelength signal to multiple time-division-multiplexed-sub-carrier channels, so that a dynamic resource assignment can be performed for each ONU.

One aspect of the present invention to prevent subscribers, which can be accommodated in a PON, from being restricted by the number of distributable wavelengths by using not a wavelength routing but a passive optical power splitter in an existing WDM-PON topology, thus enabling the same signals to be transferred to all ONUs.

Another aspect of the present invention to provide a SCM-PON, which can dynamically assign a data transmission bandwidth through selective control of a wavelength channel and a sub-carrier channel according to the service levels required between an OLT and an ONU.

In one embodiment, there is provided a Sub-Carrier Multiplexing (SCM)-Passive Optical Network (PON) using Wavelength Division Multiplexing (WDM), the SCM-PON using WDM including: an Optical Line Terminal (OLT) for transferring downstream data from an external service provider through downstream optical signals and transferring upstream data transferred through upstream optical signals to an outside; an Optical Distribution Network (ODN) for distributing the downstream optical signals from the OLT and multiplexing the upstream optical signals to the OLT; and a plurality of Optical Network Units (ONUs) for processing the downstream optical signals transferred from the OLT through the ODN and transferring upstream data of subscribers for the OLT through the upstream optical signals, wherein the optical signals between the OLT and the ONUs are divided into wavelength channels with different wavelengths and sub-carrier channels obtained by time-dividing the wavelength channels, and the upstream data and the downstream data are transferred through the sub-carrier channels.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a conventional WDM PON;

FIG. 2 is a block diagram illustrating the construction of a SCM-PON according to one embodiment of the present invention;

FIG. 3 is a diagram illustrating sub-carrier channels included in downstream data transmission wavelength channels according to an embodiment of the present invention;

FIG. 4 is a diagram illustrating assignment of time slots per each ONU in the control sub-carrier channel as illustrated in FIG. 3 according to an embodiment of the present invention;

FIG. 5 is a diagram illustrating the construction of an OLT in a SCM-PON according to an embodiment of the present invention;

FIG. 6 is a diagram illustrating the construction of each ONU in a SCM-PON according to an embodiment of the present invention;

FIG. 7 is a flow diagram illustrating registration and initialization processes of an ONU in a SCM-PON according to an embodiment of the present invention;

FIG. 8 is a flow diagram illustrating a downstream data transmission process in a SCM-PON according to an embodiment of the present invention; and

FIG. 9 is a flow diagram illustrating an upstream data transmission process in a SCM-PON according to an embodiment of the present invention.

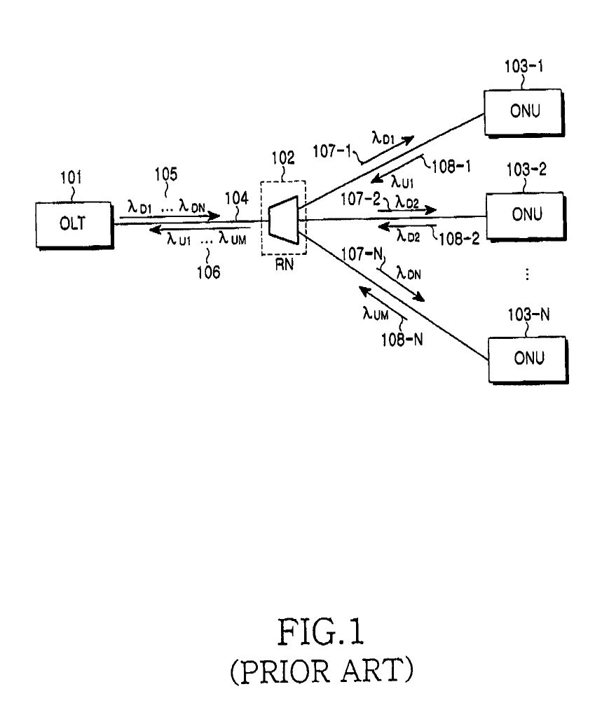

### DETAILED DESCRIPTION

An embodiment of the present invention will be described in detail herein below with reference to the accompanying drawings. It should be noted that the similar components are designated by similar reference numerals although they are illustrated in different drawings. For the purposes of clarity and simplicity, a detailed description of known functions and configurations incorporated herein will be omitted as it may obscure the subject matter of the present invention.

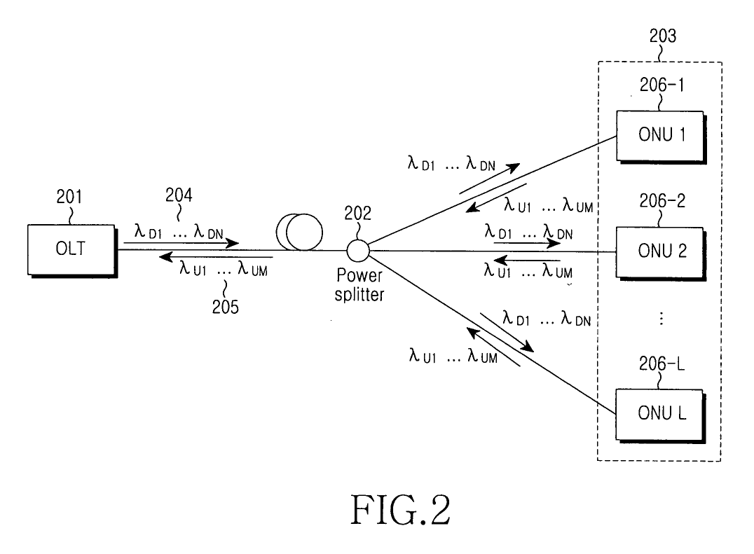

FIG. 2 is a block diagram illustrating the construction of a SCM-PON according to an embodiment of the present invention.

According to the teachings of the present invention, a passive optical power splitter 202 is utilized to dynamically control and assign transmission bandwidth by employing a Sub-Carrier Multiplexing (SCM).

The SCM-PON according to the present invention may be largely classified into three components, i.e. an Optical Line Terminal (OLT), an Optical Distribution Network (ODN), and Optical Network Units (ONUs). The OLT transfers data from an external service provider through optical signals and transfers upstream data transferred through optical signals to an outside. The ODN distributes downstream optical signals from the OLT and multiplexes upstream optical signals to the OLT. Each of the ONUs processes optical signals transferred from the OLT through the ODN and transfers upstream data of subscribers for the OLT through upstream optical signals. The ODN corresponds to a passive optical power splitter 202 for splitting optical power.

Hereinafter, a process for transmitting data from the OLT 201 to a predetermined ONU 206-1 will be described.

The SCM-PON according to the present invention uses optical signals of multiple wavelengths in upstream and downstream signals, as in the case of a WDM-PON. The optical signals of multiple wavelengths are not assigned to each subscriber. That is, the optical signals are applied so that the area of the optical signals can increase by the number of wavelengths, as compared with a case in which optical signals are time-divided for one wavelength in a TDM-PON.

Each of the optical signals of multiple wavelengths divided as described above will be referred to as a wavelength channel, and each area time-division-multiplexed according to wavelength channels will be referred to as a sub-carrier channel.

Sub-carrier channels are assigned to each subscriber. Information on sub-carrier channels according to subscribers assigned as described above is transferred through a control message before the transmission of information on each wavelength channel and each sub-carrier channel within said each wavelength channel, so that data transmission can be performed for each subscriber.

This will be described in detail with reference to FIG. 2. In downstream data transmission, the OLT 201 executes a bandwidth assignment algorithm according to both the size of data to be transmitted to the predetermined ONU 206-1 and service levels. That is, the OLT 201 determines both positions (i.e. one or more wavelength channels of λ_{Di}) of downstream data transmission wavelength channels (λ_{Di}, i=1, 2, 3, . . . , N) 204 and positions (i.e. one or more sub-carrier channels) of sub-carrier channels within the wavelength channels as data transmission sub-carrier channels for the predetermined ONU 206-1. Then, the OLT 201 assigns the downstream data transmission wavelength channels and the sub-carrier channels for data transmission, and loads data on the channels.

Herein, the OLT 201 transmits information on the downstream data transmission wavelength channels and the sub-carrier channels, which are assigned for data transmission, to the ONU group 203 through a control sub-carrier channel prior to data transmission. This will be referred to as channel control signals. After the predetermined ONU 206-1 receives the channel control signals, the predetermined ONU 206-1 controls a receiver therein according to the received channel control signals, and gets ready to receive the data transmission wavelength channels and the sub-carrier channels determined by the OLT 201.

The downstream data transmission wavelength channels 204 including data generated by the OLT 201 are transmitted downward. The transmitted downstream data transmission wavelength channels 204 are split by the passive optical power splitter 202, and are identically transferred to all ONUs 206-1 to 206-L in the ONU group 203. Then, only the predetermined ONU 206-1 having received the channel control information in advance receives the data from the transferred downstream data transmission wavelength channels 204. In this way, the downstream data transmission process is completed.

Hereinafter, a process for transmitting data from the predetermined ONU 206-1 to the OLT 201 will be described.

When data to be transmitted from the predetermined ONU 206-1 to the OLT 201 are generated, the predetermined ONU 206-1 transmits an upstream data channel assignment request to the OLT 201 by means of a control sub-carrier channel according to both the size of data and service levels.

After receiving the upstream data channel assignment request, the OLT 201 executes a bandwidth assignment algorithm based on the content of the received upstream data channel assignment request. That is, the OLT 201 determines both positions (i.e. one or more wavelength channels of λ_{Ui}) of assignable upstream data transmission wavelength channels (λ_{Ui}, i=1, 2, 3, . . . , M) 205 and positions (i.e. one or more sub-carrier channels) of sub-carrier channels within the wavelength channels as upstream data transmission sub-carrier channels of the predetermined ONU 206-1. Then, the OLT 201 assigns the upstream data transmission wavelength channels and the sub-carrier channels for data transmission, and transfers the upstream data transmission sub-carrier channels to the predetermined ONU 206-1 through a control sub-carrier channel (channel control signals).

Further, the predetermined ONU 206-1 loads upstream data on the sub-carrier channels according to information received through the channel control signals, and transmits the upstream data to the OLT 201. The information represents information regarding the positions (i.e. one or more wavelength channels of λ_{Ui}) of the assignable upstream data transmission wavelength channels (λ_{Ui}, i=1, 2, 3, . . . , M) 205 and the positions (i.e. one or more sub-carrier channels) of the sub-carrier channels within the wavelength channels.

Further, the wavelength channels transmitted from each of the ONUs 206-1 to 206-L are manually coupled by the passive optical power splitter 202 and are transmitted to the OLT 201. The OLT 201 receives the upstream data, which have been transmitted from each of the ONUs 206-1 to 206-L, according to the downstream data transmission sub-carrier channel information assigned in advance.

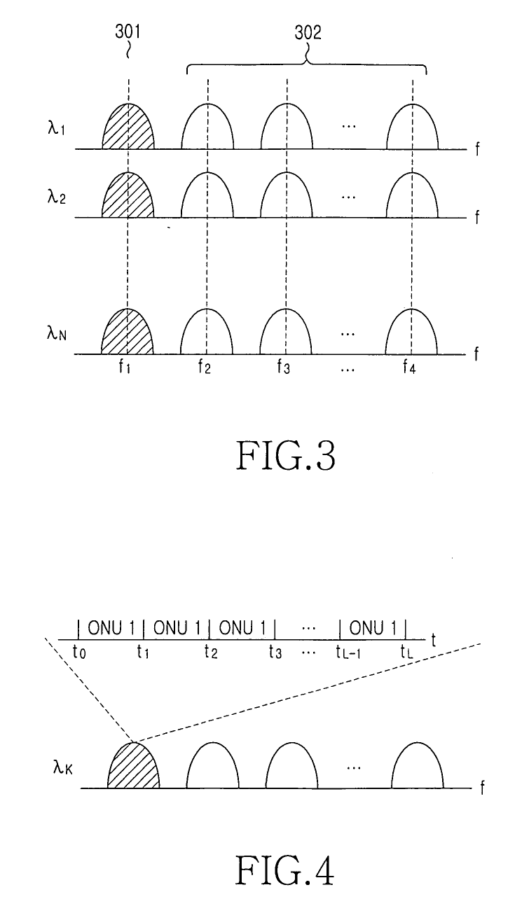

FIG. 3 is a diagram illustrating sub-carrier channels included in the downstream data transmission wavelength channels according to an embodiment of the present invention.

Referring to FIG. 3, each of the downstream data transmission wavelength channels according to the embodiment of the present invention includes one control sub-carrier channel 301 and number (K-1) of data sub-carrier channels 302.

In FIG. 3, the control sub-carrier channel 301 is located at the first sub-carrier channel for illustrative purposes. However, it should be noted that the control sub-carrier channel 301 may also be located at channels of other positions according to the teachings of the present invention.

Note that the sub-carrier channels in the upstream data transmission wavelength channels according to the embodiment of the present invention are equal to those included in the downstream data transmission wavelength channels according to the embodiment of the present invention as illustrated in FIG. 3.

FIG. 4 is a diagram illustrating assignment of time slots per each ONU in the control sub-carrier channel as illustrated in FIG. 3 according to an embodiment of the present invention. In particular, FIG. 4 illustrates a control sub-carrier channel within one of the downstream data transmission wavelength channels according to the embodiment of the present invention.

As shown, in the control sub-carrier channel within said one wavelength channel, L number (i.e. the number of ONUs) of time slots are provided, wherein one specific time slot is designated to each ONU, and each designated time slot includes control information on each ONU according to the designated time slots. The control information on each ONU included in the designated time slot corresponds to information on downstream data transmission wavelength channels and sub-carrier channels assigned for data transmission.

A control sub-carrier channel within one of the upstream data transmission wavelength channels according to the embodiment of the present invention is equal to the control sub-carrier channel within one of the downstream data transmission wavelength channels according to the embodiment of the present invention as illustrated in FIG. 4. However, the information included in each time slot is replaced with information on both the size of data to be transmitted from each ONU to the OLT and service levels.

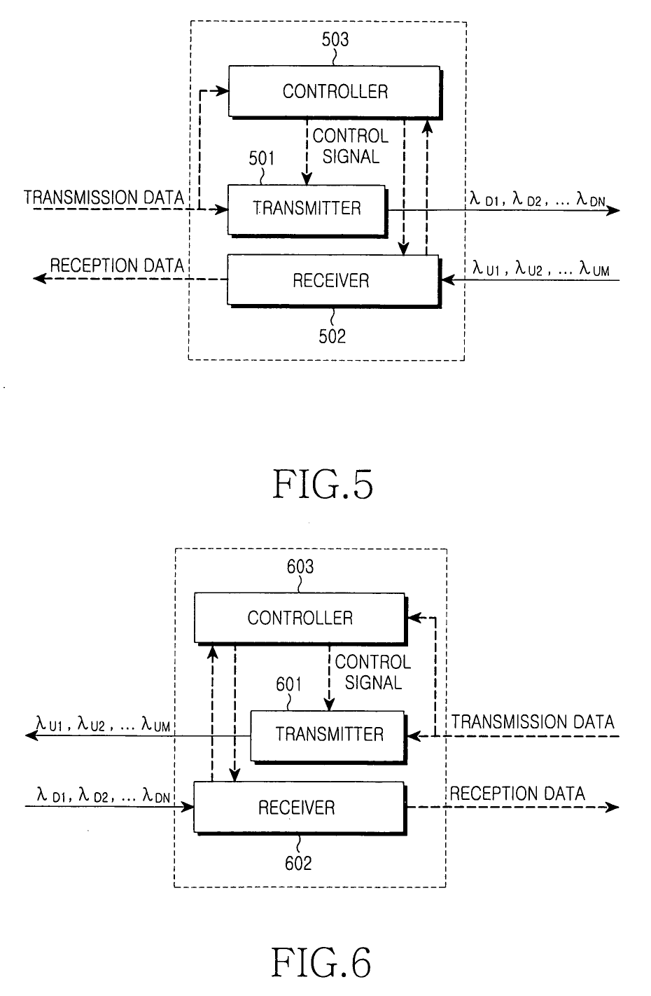

FIG. 5 is a diagram illustrating the construction of the OLT 201 in the SCM-PON according to an embodiment of the present invention.

Referring to FIG. 5, the OLT 201 in the SCM-PON according to the embodiment of the present invention includes a transmitter 501 for generating the downstream data transmission wavelength channels 204, a receiver 502 for receiving the upstream data transmission wavelength channels 205, and a controller 503 for dynamically determining the type of a wavelength channel used for transmission/reception, the type of a sub-carrier channel, and the number of sub-carrier channels with respect to each ONU in the ONU group 203, and controlling the transmitter 501 and the receiver 502.

The controller 503 executes a bandwidth assignment algorithm for determining and assigning the downstream and upstream data transmission wavelength channels 204 and 205, and sub-carrier channels according to both the size of data to be transmitted from the OLT 201 and each ONU in the ONU group 203 and service levels. The results obtained by executing the bandwidth assignment algorithm are transmitted from the transmitter 501 to the ONU group 203 through the control sub-carrier channel 301.

The transmitter 501 includes a laser diode array and a sub-carrier multiplexer for generating a control sub-carrier channel and a data transmission sub-carrier channel within a separate wavelength channel. The transmitter 501 loads either the channel control signals (i.e. the results of the bandwidth assignment algorithm), which are transferred from the controller 503, or input data signals on an assigned sub-carrier, and optically transmits the sub-carrier to the ONU group 203.

The receiver 502 includes a wavelength demultiplexer and a sub-carrier multiplexer array. The receiver 502 selects the received upstream data transmission wavelength channels and sub-carrier channels according to the channel control signals (i.e. the results of the bandwidth assignment algorithm), which are transferred from the controller 503, and receives upstream data from each of the ONUs 206-1 to 206-L.

The upstream data correspond to request messages for upstream data channels from each of the ONUs 206-1 to 206-L or data signals from each of the ONUs 206-1 to 206-L. In the case of the request messages for upstream data channels, the receiver 502 transfers the request messages to the controller 503 so as to execute the bandwidth assignment algorithm.

FIG. 6 is a diagram illustrating the construction of each ONU in the SCM-PON according to an embodiment of the present invention.

Referring to FIG. 6, each of the ONUs 206-1 to 206-L in the SCM-PON according to the embodiment of the present invention includes a transmitter 601 for performing transmission of the upstream data transmission wavelength channels 205 to the OLT 201, a receiver 602 for selectively receiving wavelength channels and sub-carrier channels from the downstream data transmission wavelength channels 204, and a controller 603 for taking charge of control necessary for transmission and reception of data and control signals.

Specifically, when the predetermined ONU 206-1 is to transmit data to the OLT 201, the controller 603 transmits the size of the data to be transmitted and service request levels to the OLT 201 through the control sub-carrier channel 301, receives assignment information on upstream data transmission wavelength channels and sub-carrier channels, which are to be used by the predetermined ONU 206-1, from the OLT 201, determines data wavelength channels and sub-carrier channels, which are to be used by the transmitter 601, and forms the upstream channel 205. When the OLT 201 transmits data to the predetermined ONU 206-1, the controller 603 selects a wavelength channel and a sub-carrier channel based on the channel control information received from the OLT 201, and controls the receiver 602 to receive data of a corresponding position.

The transmitter 601 includes a light source unit with a multi-wavelength generator using a laser diode array, a wavelength-tunable laser diode, etc., and a sub-carrier multiplexer capable of generating a control sub-carrier channel and a data transmission sub-carrier channel within a separate wavelength channel. The transmitter 601 loads upstream transmission data on a specific sub-carrier channel according to control signals from the controller 603, and transmits the specific sub-carrier channel to the OLT 201.

The receiver 602 includes an optical filter array and a photodiode array, or a tunable optical filter and a photodiode, and a sub-carrier demultiplexer. The receiver 602 selects a sub-carrier channel of a predetermined position from the downstream data transmission wavelength channels, which have been transmitted from the OLT 201, according to control signals from the controller 603, and receives data included in the corresponding sub-carrier channel.

The SCM-PON according to the present invention enables all subscribers to share available wavelengths, dynamically assigns bandwidth according to the size of generated upstream and downstream data and service request levels, and transmits the upstream and downstream data, instead of using a method for assigning one fixed wavelength to one subscriber in the existing WDM-PON.

In such a method, information on data to be transmitted between the OLT 201 and the predetermined ONU 206-1 is applied to the dynamic bandwidth assignment algorithm of the OLT 201, wavelength channels and sub-carrier channels are dynamically assigned, and information on the channel assignment is transferred through the control sub-carrier channel 301.

Further, when a service level changes while a service is provided between the OLT 201 and the predetermined ONU 206-1 by means of the information on the channel assignment, information on the change is transferred to the controller of the OLT 201. Accordingly, the dynamic bandwidth assignment algorithm is newly executed, so that new channel assignment is performed. As a result, it is possible to actively cope with the change in a subscriber service level. The service level may be defined by data transmission amount (or the number of packets) between the OLT 201 and the predetermined ONU 206-1, Quality of Service (QoS), etc.

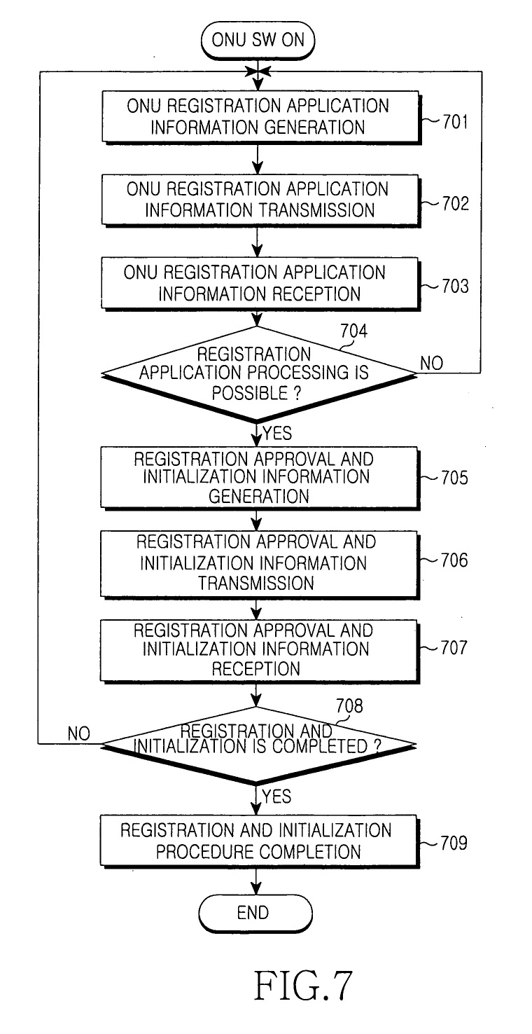

FIG. 7 is a flow diagram illustrating the registration and initialization processes of an ONU in the SCM-PON according to an embodiment of the present invention.

Referring to FIG. 7, if the predetermined ONU 206-1 is initiated, the controller 603 of the ONU 206-1 generates registration application information (701) and transmits the registration application information to the OLT 201 (702).

The receiver 502 of the OLT 201 receives the registration application information (703) and transfers the registration application information to the controller 503 of the OLT 201. The controller 503 determines if the registration application from the predetermined ONU 206-1 can be processed (704).

As a result of the determination, if the registration is possible, the controller 503 of the OLT 201 generates registration approval information and initialization information of transmission/reception channels (705) and then transmits the information to the ONU 206-1 (706).

Thereafter, the controller 603 of the ONU 206-1 determines if the registration and initialization have been completed based on the received registration approval information and initialization information (708). If the registration and initialization have been completed, the controller 603 of the ONU 206-1 stores the registration and initialization information (709), initializes the transmitter 601 and the receiver 602 of the ONU 206-1, and completes the registration and initialization processes.

As a result of the determination in step 704 and 708, if the registration is not possible or if the registration and initialization have not been completed, step 701 is performed.

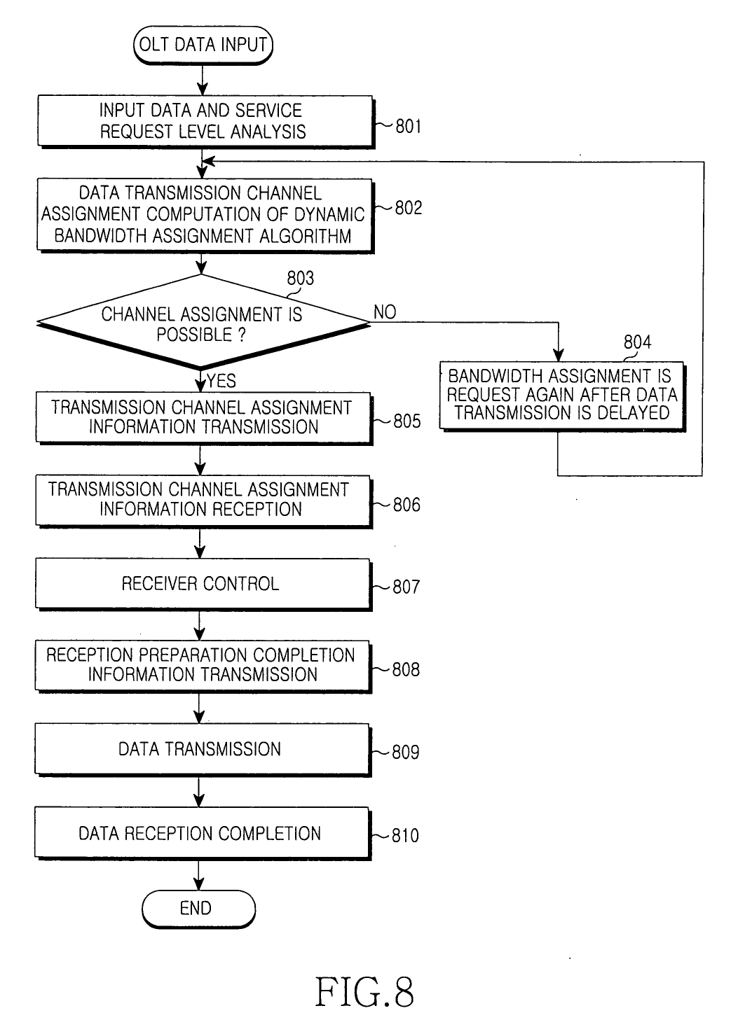

FIG. 8 is a flow diagram illustrating a downstream data transmission process in the SCM-PON according to an embodiment of the present invention.

Referring to FIG. 8, data input to the OLT 201 are transferred to the controller 503 of the OLT 201, and the size of data and service request levels are analyzed (801).

The analysis results are used for computing assignment of data transmission channels according to the bandwidth assignment algorithm of the controller 503 (802). As a result of the computation, the controller 503 determines if the assignment of data transmission channels is possible (803). If the assignment of data transmission channels is possible, the controller 503 transmits data transmission channel assignment information to the specific ONU 206-1 intended for the reception of data (805). However, if the assignment of data transmission channels is not possible, data transmission is delayed, and a bandwidth assignment request for data transmission is transmitted to the controller 503 again after a predetermined time expires (804). This process repeats up to a point at which the assignment of data transmission channels is accomplished or data must be discarded.

The data transmission channel assignment information transmitted to the ONU 206-1 after the data transmission channel are assigned is received through the receiver 602 of the ONU 206-1 (806) and is transferred to the controller 603 of the ONU 206-1. The controller 603 of the ONU 206-1 controls the receiver 602 of the ONU 206-1 to receive data corresponding to the data transmission channel assignment information. Accordingly, the receiver 602 of the ONU 206-1 gets ready to receive the data (807) and transmits a reception preparation completion information to the OLT 201 (808).

Further, the controller 503 of the OLT 201 transmits data to the ONU 206-1 through a previously assigned data transmission channel by using the transmitted 501 (809). The ONU 206-1 receives the data and completes the data transmission procedure from the OLT 201 (810).

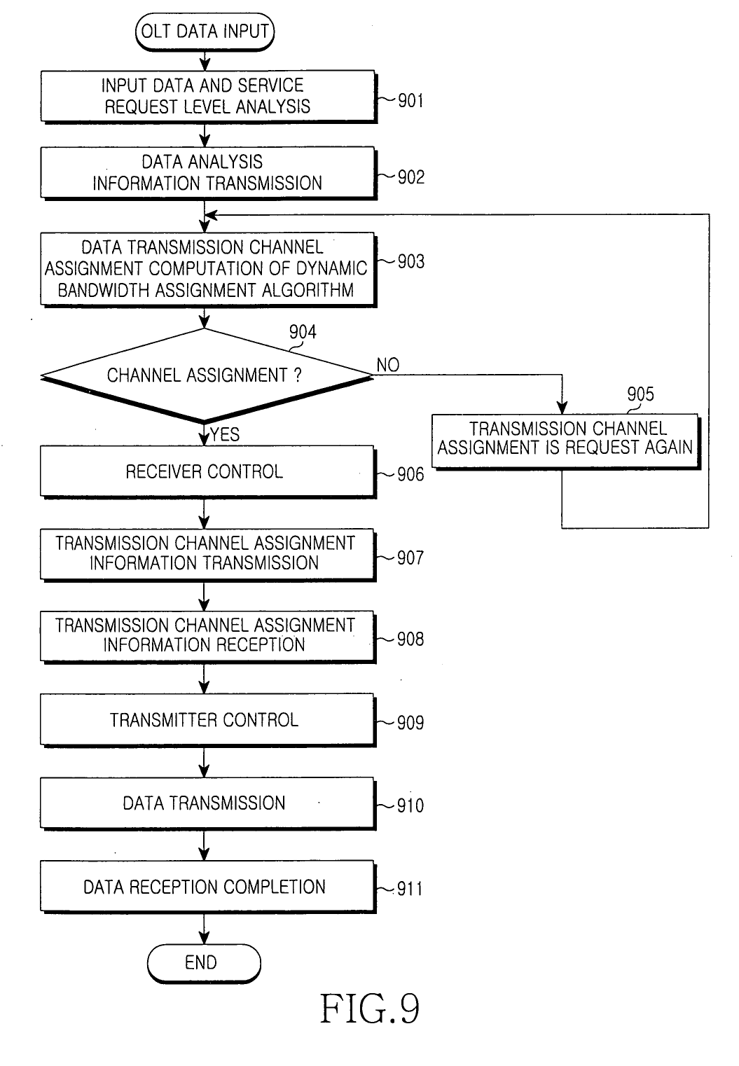

FIG. 9 is a flow diagram illustrating an upstream data transmission process in the SCM-PON according to an embodiment of the present invention.

Referring to FIG. 9, data input to the ONU 206-1 are transferred to the controller 603 of the ONU 206-1, and the size of data and service request levels are analyzed (901). The analysis results are transmitted to the OLT 201 through the control sub-carrier channel 301(902).

The received analysis results are transferred to the controller 503 of the OLT 201. The controller 503 of the OLT 201 executes the bandwidth assignment algorithm, computes data transmission channels to be assigned to the ONU 206-1 (903), and determines if bandwidth assignment is possible (904). If the bandwidth assignment is not possible, transmission channel assignment is repeatedly requested at regular time intervals up to a point at which the bandwidth assignment is possible (905). If the bandwidth assignment is not possible after a preset waiting time passes, the assignment request is discarded. However, if the bandwidth assignment is possible, the controller 503 of the OLT 201 controls the receiver 502 of the OLT 201 to be in a waiting state for receiving data from the ONU 206-1 by means of the bandwidth assignment results (906), and transmits transmission channel assignment information based on the bandwidth assignment results to the ONU 206-1(907).

Then, the ONU 206-1 receives the transmission channel assignment information (908) and transfers the transmission channel assignment information to the controller 603 of the ONU 206-1. The controller 603 of the ONU 206-1 controls the transmitter 601 of the ONU 206-1 according to the received transmission channel assignment information (909). Accordingly, the transmitter 601 of the ONU 206-1 starts data transmission (910).

If the data transmitted from the ONU 206-1 are received in the OLT 201, the data transmission procedure of the ONU 206-1 is completed (911).

Note that the above-described method according to the present invention can be realized as software and can be stored in a recoding medium such as a CD ROM, an RAM, a floppy disk, a hard disk, or a magneto-optical disk, so that a user can read such software by using a computer.

According to the present invention as described above, a WDM-PON scheme and a TDM-PON scheme are commonly used, all ONUs use multiple wavelength signals, and each wavelength signal is assigned to multiple time-division-multiplexed-sub-carrier channels, so that a dynamic resource assignment can be performed for each ONU. Therefore, it is possible to prevent subscribers, which can be accommodated in a PON, from being restricted by the number of distributable wavelengths by using not a wavelength routing but a passive optical power splitter in an existing WDM-PON topology and enabling the same signals to be transferred to all ONUs. Furthermore, it is possible to dynamically assign data transmission bandwidth through selective control of a wavelength channel and a sub-carrier channel according to service levels required between an OLT and an ONU.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A Sub-Carrier Multiplexing (SCM)-Passive Optical Network (PON) using Wavelength Division Multiplexing (WDM), comprising:
an Optical Line Terminal (OLT) for transferring downstream data from an external service provider through downstream optical signals and transferring upstream data transferred through upstream optical signals to an outside;
an Optical Distribution Network (ODN) for distributing the downstream optical signals from the OLT and multiplexing the upstream optical signals to the OLT; and
a plurality of Optical Network Units (ONUs) for processing the downstream optical signals transferred from the OLT through the ODN and transferring upstream data of subscribers for the OLT through the upstream optical signals,
wherein the optical signals between the OLT and the ONUs are divided into wavelength channels with different wavelengths and sub-carrier channels obtained by time-dividing the wavelength channels so that the upstream data and the downstream data are transferred through the sub-carrier channels.

2. The SCM-PON using WDM as claimed in claim 1, wherein the ODN includes an optical power splitter.

3. The SCM-PON using WDM as claimed in claim 1, wherein the sub-carrier channel is classified into a control sub-carrier channel for transmitting a dynamic bandwidth control information between the OLT and the ONUs in each of the wavelength channels, and a data sub-carrier channel for transmitting the upstream data and the downstream data.

4. The SCM-PON using WDM as claimed in claim 3, wherein the control sub-carrier channel has time slots corresponding to a number of the ONUs in order to control each of the ONUs and to load the dynamic bandwidth control information on each of the ONUs on the time slots, respectively.

5. The SCM-PON using WDM as claimed in claim 3, wherein the OLT executes a dynamic bandwidth assignment algorithm for downstream transmission according to an input of the downstream data, inserts results obtained by executing the dynamic bandwidth assignment algorithm into the control sub-carrier channel, and loads the downstream data on the data sub-carrier channel according to the results.

6. The SCM-PON using WDM as claimed in claim 3, wherein the OLT executes a dynamic bandwidth assignment algorithm for upstream transmission according to upstream bandwidth assignment requests from the ONUs, inserts results obtained by executing the dynamic bandwidth assignment algorithm into the control sub-carrier channel, transmits the control sub-carrier channel to the ONUs, and receives the upstream data from positions based on the results in the upstream optical signals transferred from the ONUs.

7. The SCM-PON using WDM as claimed in claim 5, wherein the OLT re-executes the dynamic bandwidth assignment algorithm for the downstream transmission according to change in both a size of the downstream data input between the OLT and the ONUs and service request levels, and adaptively provides bandwidth for the downstream data.

8. The SCM-PON using WDM as claimed in claim 6, wherein the OLT re-executes the dynamic bandwidth assignment algorithm for the upstream transmission according to change in both a size of the upstream data input between the OLT and the ONUs and service request levels, and adaptively provides bandwidth for the upstream data.

9. The SCM-PON as claimed in claim 4, wherein a number of the time slots included in the control sub-carrier channel changes depending on a change in the number of the ONUs coupled to the OLT.
